(19) United States
(12) Patent Application Publication
(10) Pub. No.: US 2013/0087168 A1
(43) Pub. Date: Apr. 11, 2013

(54) Roof Debris Removal Apparatus and Method of Use

(71) Applicant: Beville James, Gainesville, GA (US)

(72) Inventor: Beville James, Gainesville, GA (US)

(21) Appl. No.: 13/253,404

(22) Filed: Oct. 5, 2011

(51) Int. Cl. B08B 1/00; A47L 5/00; B08B 7/00

(52) U.S. Cl. 134/6; 15/3; 15/405

(57) ABSTRACT

A roof debris removal apparatus comprising a generally rectangular platform with a plurality of omnidirectional rollers disposed at the bottom corners thereof, with a telescopic pole connected to the platform for manipulating the apparatus in multiple directions across a roof surface by an operator standing on the ground. A leaf blower, floor dryer or a water jet mechanism is secured to the platform, and a power source is connected to the leaf blower, floor dryer or a water jet mechanism. The apparatus is utilized to remove debris, such as leaves and twigs, from a roof surface.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to devices for removal of leaves and other debris from elevated surfaces, and more specifically to an apparatus for removal of debris such as leaves and similar from a building roof.

2. Description of Related Art

Building roofs provide a surface for accumulation of debris, such as leaves, twigs, branches and other matter. During high winds or in Fall when trees shed their leaves, roofs will sustain a buildup of such debris. Such a buildup creates both an unsightly appearance and a hazardous condition where branches are large and may fall uncontrolled, and, further, can cause damage to a roof where moisture, ice and/or snow may accumulate leading to rotting. Moreover, accumulation of ice and/or snow may place an unsupportable weight upon the roof.

Removal of accumulated debris is typically accomplished by an operator ascending a ladder with either hoses for water or electrical blowing devices attached to an extension cord. The debris is then dislodged by spraying water from the hose and/or using the electrical blowing device in the same fashion as it is used for leaves and such on the ground by directing the air stream from the electrical blowing device at the debris. Unfortunately, the necessity of climbing a ladder, and, subsequently, walking across a roof surface that is often steeply sloped, are both hazardous, particularly for individuals who have little experience in such work on elevated surfaces. Moreover, transport of such electrical blowing devices and water hoses to the roof while ascending the ladder compounds the hazardous condition.

Various devices have attempted to solve the above-referenced problem by providing a device that can be operated from the ground. One such device comprises a telescopic tubular handle through which water flows to nozzles that spray the water onto the roof surface to dislodge any debris. The user may manipulate the nozzles along the roof surface parallel to the tubular handle via a wheeled support to which the nozzles are attached. Unfortunately, this device does not readily allow for side to side motion along the roof surface, and, thus, must be reposition with great effort before a new section of roof can be cleared. Furthermore, because water is being sprayed, such can enter any crevices in the roof or walls supporting the roof, thereby causing damage.

Another device comprises a flexible extension tube with a fixed nozzle end. The tube is attached at its other end to a leaf blower. The extension tube is supported and manipulated by a tubular pole held by the user from the ground. The nozzle is then directed into gutters to remove debris therefrom. While this device overcomes the need to ascend the roof, again, since this device requires water, damage to the roof may result, and, further, it is limited to clearance of gutters.

Therefore, it is readily apparent that there is a need for a roof debris removal apparatus that can be manipulated in all directions across a roof surface, and which can be so operated by a person standing on the ground.

### BRIEF SUMMARY OF THE INVENTION

Briefly described, in a preferred embodiment, the present invention overcomes the above-mentioned disadvantages and meets the recognized need for such a device by providing a roof debris removal apparatus having a platform that can roll in multiple directions across a roof surface when manipulated from a telescopic pole by an operator standing on the ground. Rolling is accomplished via spherical or similar rollers on the bottom surface of the platform, the rollers permitting rolling of the platform in any direction. The apparatus includes either a blowing apparatus, such as, for exemplary purposes only and without limitation, a leaf blower or floor dryer supported by the platform and downwardly-directed, or water nozzles similarly supported and directed.

According to its major aspects and broadly stated, the present invention in its preferred form is a roof debris removal apparatus comprising a support mechanism, a plurality of omnidirectional rollers, a manipulating member, such as, for exemplary purposes only, a telescopic pole, and a debris removal mechanism, such as, for exemplary purposes only, a leaf blower, a floor dryer or at least one water jet nozzle. The support mechanism is preferably a generally rectangular platform and the omnidirectional rollers are preferably spherical.

In the preferred embodiment, an electrical cord is in electrical communication with an electrical power source and debris removal mechanism. The electrical cord is disposed within or alongside the telescoping pole. When water jet nozzles are utilized, a hose member is disposed within or alongside the telescoping pole and is connected to a water pressure source. It will be recognized by those skilled in the art that the hose member could be secured to one end of the telescoping pole to allow passage of water through the telescoping pole to the other end of the telescoping pole which is connected to the water jet nozzles.

In use, the debris removal mechanism is secured to the support mechanism such as, for exemplary purposes only, a platform. The platform may include a mount for the debris removal mechanism, and the combined support mechanism and debris removal mechanism are positioned on a surface to be cleaned of debris. It will be recognized by those skilled in the art that the debris removal mechanism may be secured to the platform or mount via, without limitation, straps, bungees, screws, bolts/nuts, clamps, and the like.

The debris removal mechanism is connected to a power source, and the combination is moved in any selected direction across the surface via the telescopic pole, thereby removing the debris from the surface.

More specifically, the present invention is a roof debris removal apparatus having a platform support base, a blower, a mount, a telescoping pole, a power cord and a pole attachment point. The platform support base comprises a securing ring with a first set of threads thereon, a top surface and a bottom surface. The bottom surface comprises sockets with second set threads therein. The first set of threads cooperatively engages the second set of threads, thereby retaining an omnidirectional roller within each socket. Preferably three omnidirectional rollers are utilized. The roof debris removal apparatus is further supported in part via the telescoping pole.

The power cord is selectively disposed within or alongside the telescoping pole, and has a power cord end that is secured to and electrically connects to the blower. The blower is preferably removably secured to the platform support base. The pole attachment point is selectively configured as a fixed attachment point to prevent turning of the platform support base, or, alternatively, configured as a pivot, if the roof debris removal apparatus is desired to be steerable.

In use, an operator switches the blower on and lifts the roof debris removal apparatus to a roof surface of a building by using the telescoping pole to support and maneuver the roof debris removal apparatus. Subsequently, the operator engages the power cord with any suitable source of electrical power as is required by the blower, thus starting the blower. The operator then moves the roof debris apparatus forward, backward or sideways as needed to direct an air stream that disengages debris, such as leaves, from the roof surface. The operator selectively increases or decreases the length of the telescoping pole as required.

When removal of leaves or other debris is complete, the operator disengages the power cord from its electrical source and lowers the roof debris removal apparatus from the roof surface. A power switch may alternatively be included on telescoping pole to permit turning the roof debris removal apparatus on and off without the need to remove the power cord from the power source.

In preferred embodiment, the roof debris removal apparatus may utilize a floor dryer with its air stream directed downward and along the roof surface, or, may have a nozzle rack connected to a water pressure source for dispensing water streams downward and along the roof surface.

Accordingly, a feature and advantage of the present invention is its ability to clean roofs of leaves, branches, twigs and the like.

Another feature and advantage of the present invention is its ability to utilize different types of existing apparatuses for cleaning a roof.

Still another feature and advantage of the present invention is its ability to provide a safe means of cleaning a roof without climbing a ladder.

Yet another feature and advantage of the present invention is its ability to be maneuvered in any required direction once it is on a roof.

Yet still another feature and advantage of the present invention is its ability to use electric or water power.

A further feature and advantage of the present invention is its ability to by utilized on a variety of roof surfaces.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, which are not necessarily drawn to scale, and in which like reference numerals denote similar structure and refer to like elements throughout, and in which:

FIG. 1 is a perspective view of a roof debris removal apparatus according to a preferred embodiment, shown in use;

FIG. 2A is a side perspective view of a three-roller platform component of the roof debris removal apparatus of FIG. 1;

FIG. 2B depicts a bottom view of the three-roller platform component of the roof debris removal apparatus of FIG. 2A;

FIG. 3A is a side perspective view of a four-roller platform component of the roof debris removal apparatus according to a preferred embodiment;

FIG. 3B depicts a bottom view of the four-roller platform component of the roof debris removal apparatus of FIG. 3A;

FIG. 4A is a side perspective view of the roof debris removal apparatus according to the preferred embodiment of FIG. 1;

FIG. 4B is a side perspective view of a roof debris removal apparatus according to an alternate embodiment of FIG. 1;

FIG. 4C is a side perspective view of a roof debris removal apparatus according to another alternate embodiment of FIG. 1; and

FIG. 5 depicts a detail cross-sectional view of the roller and platform components of FIGS. 4A-4C.

### DETAILED DESCRIPTION OF THE PREFERRED AND SELECTED ALTERNATE EMBODIMENTS OF THE INVENTION

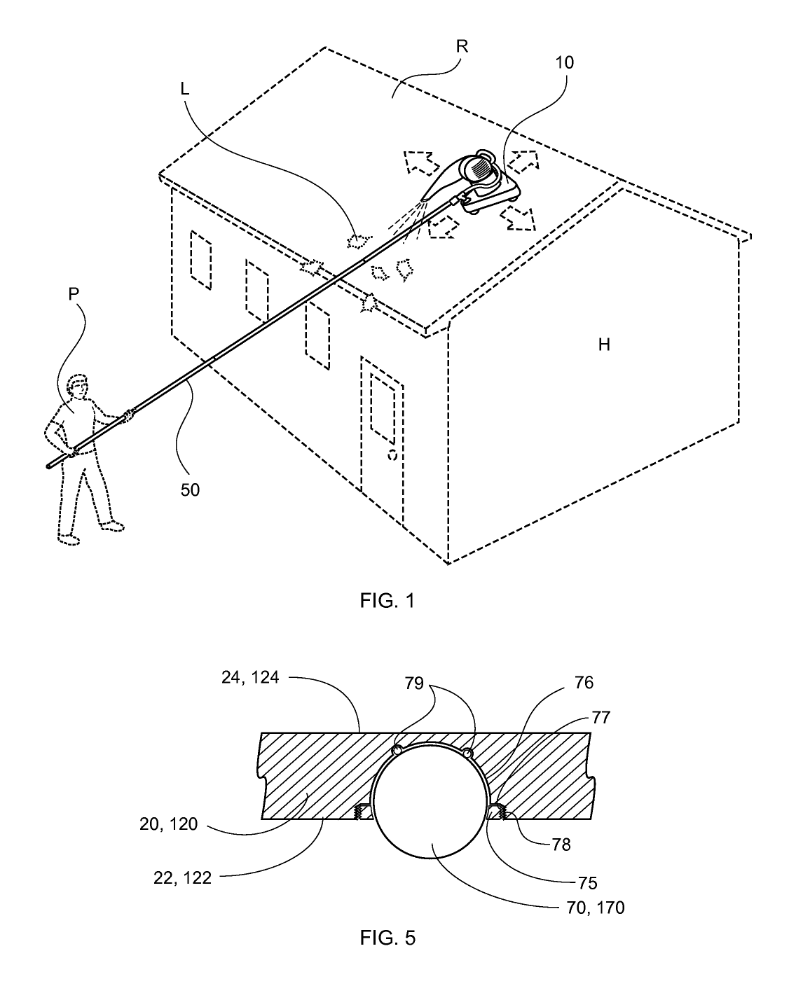

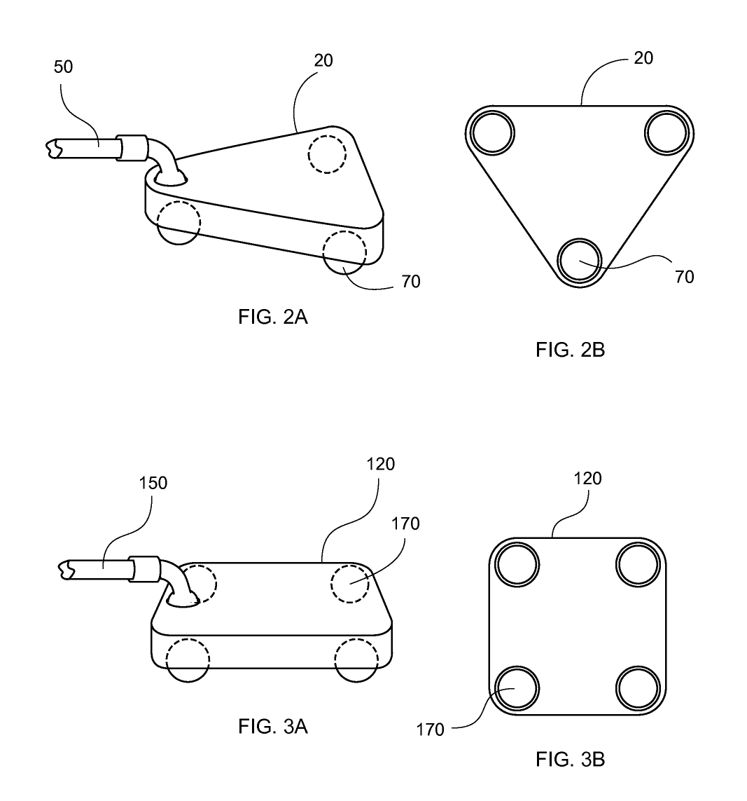

In describing the preferred and selected alternate embodiments of the present invention, as illustrated in FIGS. 1-5, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1, 2A, 2B, 4A and 5, the present invention in a preferred embodiment is roof debris removal apparatus 10 comprising platform support base 20, blower 30, mount 40, telescoping pole 50, power cord 60 and pole attachment point 80. Platform support base 20 comprises retaining or securing ring 75 with first threads therein, top surface 24 and bottom surface 22 (best shown in FIG. 5). Bottom surface 22 comprises second threads 78 and sockets 76 (best shown in FIG. 5) with preferably three omnidirectional rollers 70 disposed therein, wherein omnidirectional rollers 70 are preferably spherical, and wherein first threads 77 cooperatively engage second threads 78, and wherein securing ring 75 preferably retains omnidirectional rollers 70 within sockets 76. Sockets 76 have disposed therein bearings 79, wherein bearings 79 are disposed between sockets 76 and omnidirectional rollers 70 to facilitate rotation of omnidirectional rollers 70. It will be recognized by those skilled in the art that more or fewer than three omnidirectional rollers 70 could be utilized, with optional controlling and partially supporting of roof debris removal apparatus 10 via pole 50.

Power cord 60 is selectively disposed within or alongside telescoping pole 50, wherein power cord 60 comprises power cord end 90, and wherein power cord end 90 is in electrical communication with blower 30. Blower 30 is preferably removably secured to platform support base 20. Pole attachment point 80 is selectively configured as a fixed attachment point to prevent turning of platform support base 20, or alternatively configured as a pivot, if roof debris removal apparatus 10 is desired to be steerable.

In use, operator P switches blower 30 on and lifts roof debris removal apparatus 10 to roof surface R of building H via telescoping pole 50 and disposes roof debris removal apparatus 10 on roof surface R. Subsequently, operator P engages power cord 60 with any suitable source of electrical power as required by blower 30 as is known in the art, thereby causing blower 30 to run. Operator P then moves roof debris apparatus forward, backward or sideways as needed to direct an air stream that disengages debris, such as leaves L, from roof surface R, and wherein operator P selectively increases or decreases the length of telescoping pole 50 as required. When removal of leaves L is complete, operator disengages power cord 60 from its electrical source and lowers roof debris removal apparatus from roof surface R. It will be recognized by those skilled in the art that roof debris removal apparatus 10 could alternatively include a power switch on telescoping pole 50, thereby permitting roof debris removal apparatus 10 to be turned on and off without the need to remove power cord 60 from a power source.

Another preferred embodiment as depicted in FIGS. 3A and 3B comprises alternative support base 120 for roof debris removal apparatus 10, wherein alternative support base 120 comprises rollers 170 disposed therewithin and wherein alternative support base 120 is pivotally secured to pole 150.

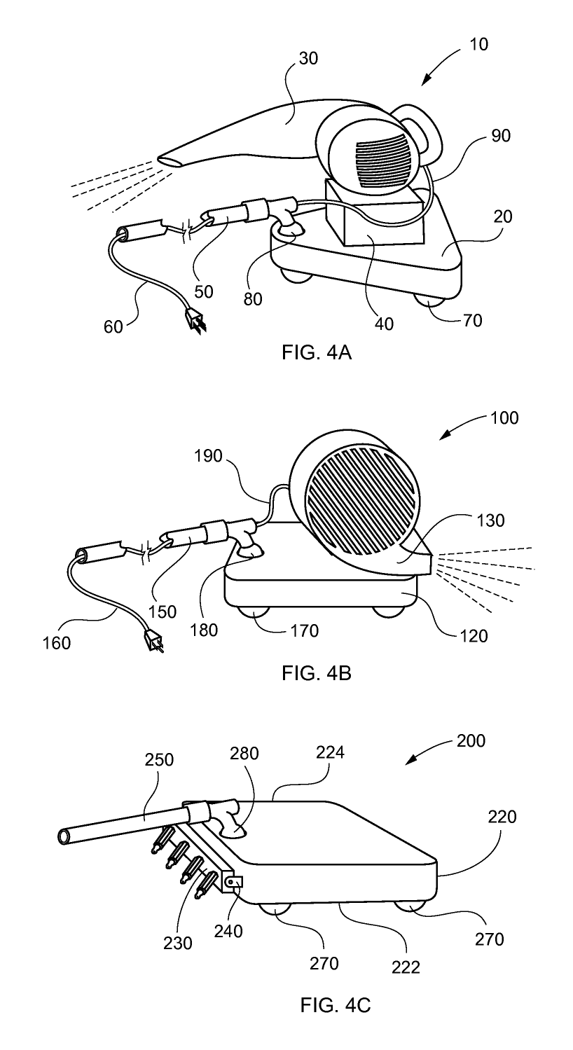

Referring now more specifically to FIGS. 4B and 5, illustrated therein is an alternate embodiment of roof debris removal apparatus 10, wherein the alternate embodiment of FIGS. 4B and 5 is substantially equivalent in form and function to that of the preferred embodiment detailed and illustrated in FIGS. 1, 2A, 2B, 4A and 5 except as hereinafter specifically referenced. Specifically, the embodiment of FIGS. 4B and 5 comprises roof debris removal apparatus 100 having support base 120, floor dryer 130, telescoping pole 150, power cord 160 and pole attachment point 180. Power cord 160 comprises power cord end 190, wherein power cord end 190 is in electrical communication with floor dryer 130, and wherein power cord 160 is disposed within or alongside telescoping pole 150. Support base 120 comprises top surface 124 and bottom surface 122 (best shown in FIG. 5), wherein bottom surface 122 has omnidirectional rollers 170 disposed therein, and wherein omnidirectional rollers 170 are secured within sockets 76 (best shown in FIG. 5).

In use, roof debris removal apparatus 100 is operated similarly to the aforementioned preferred embodiment, wherein floor dryer 130 is disposed on support base 120, and wherein floor dryer 130 is disposed to direct its air stream downward and along roof surface R.

Referring now more specifically to FIGS. 4C and 5, illustrated therein is an alternate embodiment of roof debris removal apparatus 10, wherein the alternate embodiment of FIGS. 4C and 5 is substantially equivalent in form and function to that of the preferred embodiment detailed and illustrated in FIGS. 1, 2A, 2B, 4A and 5 except as hereinafter specifically referenced. Specifically, the embodiment of FIGS. 4C and 5 comprises roof debris removal apparatus 200 having support base 220, mount 240 having nozzle rack 230 for dispensing water streams disposed thereon, telescoping pole 250 and pole attachment point 280. Support base 220 comprises top surface 224 and bottom surface 222, wherein bottom surface 222 has omnidirectional rollers 270 disposed therein, and wherein omnidirectional rollers 270 are secured within sockets 76 (best shown in FIG. 5).

In use, roof debris removal apparatus 200 is operated similarly to the aforementioned preferred and alternate embodiments except that telescoping pole 250 is connected to a water source, wherein nozzle rack 230 is disposed on support base 220, and wherein nozzle rack 230 is disposed to direct its water stream downward and along roof surface R.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A roof debris removal apparatus comprising:
a support mechanism;
a plurality of omnidirectional rollers;
a manipulating member; and
a debris removal mechanism.

2. The roof debris removal apparatus of claim 1, wherein said omnidirectional rollers are spherical.

3. The roof debris removal apparatus of claim 1, wherein said plurality comprises three omnidirectional rollers.

4. The roof debris removal apparatus of claim 1, wherein said plurality comprises four omnidirectional rollers.

5. The roof debris removal apparatus of claim 1, wherein said manipulating member comprises a pole.

6. The roof debris removal apparatus of claim 5, wherein said pole is telescopic.

7. The roof debris removal apparatus of claim 1, further comprising an electrical cord, wherein said electrical cord is in electrical communication with an electrical power source and said debris removal mechanism.

8. The roof debris removal apparatus of claim 7, wherein said electrical cord is disposed along said manipulating member.

9. The roof debris removal apparatus of claim 8, wherein said electrical cord is disposed within said manipulating member.

10. The roof debris removal apparatus of claim 1, wherein said debris removal mechanism comprises a floor dryer.

11. The roof debris removal apparatus of claim 1, wherein said debris removal mechanism comprises a leaf blower.

12. The roof debris removal apparatus of claim 1, wherein said debris removal mechanism comprises a water jet.

13. The roof debris removal apparatus of claim 12, further comprising a hose member disposed along said manipulating member, wherein said hose member is connected to a water pressure source.

14. A method of removing debris from a surface, said method comprising the steps of:
securing a debris removal mechanism to a support mechanism, wherein said support mechanism comprises a plurality of omnidirectional rollers disposed thereon, and wherein said support mechanism is secured to one end of a manipulating mechanism;
disposing said combined support mechanism and debris removal mechanism on a surface to be cleaned of debris;
energizing said debris removal mechanism via a power source;
moving said support mechanism omnidirectionally across the surface via said manipulating mechanism; and
removing the debris from the surface.

15. The method of claim 14, wherein said step of energizing said debris removal mechanism via a power source further comprises the step of:
providing electrical power to said debris removal mechanism.

16. The method of claim 14, wherein said step of energizing said debris removal mechanism via a power source further comprises the step of:
providing water power to said debris removal mechanism.

17. The method of claim 14, wherein said step of securing a debris removal mechanism to a support mechanism further comprises the step of:
securing a floor dryer to said support mechanism.

18. The method of claim 14, wherein said step of securing a debris removal mechanism to a support mechanism further comprises the step of:
securing a leaf blower to said support mechanism.

19. The method of claim 14, wherein said step of securing a debris removal mechanism to a support mechanism further comprises the step of:
securing a water jet to said support mechanism.

20. A debris removal apparatus comprising:
a generally rectangular support mechanism;
a plurality of spherical rollers, each spherical roller of said plurality of spherical rollers being disposed at a separate corner of said rectangular support mechanism;
a manipulating member;
a debris removal mechanism; and
a power source in communication with said debris removal mechanism.
